(19) United States
(12) Patent Application Publication
(10) Pub. No.: US 2007/0011715 A1
(43) Pub. Date: Jan. 11, 2007

(54) Instant switching method for a computer-television system

(76) Inventor: Wei-Yi Hsuan, Taipei (TW)

Correspondence Address: RABIN & BERDO, P.C., Suite 500, 1101 14 Street, N.W., Washington, DC, 20005, US

(21) Appl. No.: 11/175,148

(22) Filed: Jul. 7, 2005

(51) Int. Cl. H04N 7/16; H04N 7/00; H04N 7/173; H04N 11/00

(52) U.S. Cl. 725/133; 725/141; 725/153; 348/552

(57) ABSTRACT

An instant switching method for a computer-television system is described. The computer-TV system is separated into a TV operating module and a computer operating module, individually. An input/output device of the TV operating module is used for both modules of the system. When booting the system, the TV mode is first entered since the TV operating module controls the I/O system in the beginning. In the meantime, the computer system is performing the P.O.S.T. process and entering a standby mode later. The booting process of the computer is almost done while a user switches the TV mode to the computer mode.

### BACKGROUND OF THE INVENTION

1. Field of the Invention

The present invention discloses an instant switching method for a computer-television system, and, more particularly, for a computer-TV system separated into a TV operating module and a computer operating module so as to switch instantly between a computer system and a TV system.

2. Description of Related Art

An information appliance (IA) is the combination of a regular household appliance and a computer system, thereby providing a variety of functions, or resulting in more convenient applications. For example, by extending a TV converter installed into the computer system, the TV and the computer are combined together. TV programs are displayed on one of multiple windows displayed on the screen of the computer, while the TV program and computer rogram operate simultaneously. Furthermore, the TV program or other content combined with this computer-television system can be recorded in the computer system.

U.S. Pat. No. 5,249,164 discloses a computer-TV structure that simply combines a television and a computer system. A TV card with a TV tuner is mounted in the computer system. The TV card demodulates the TV signals and outputs the signals through the digitalized process inside the system without any influence on the computer system.

U.S. Pat. No. 5,502,503 shows an apparatus for displaying on a monitor screen of a computer. In addition to updating the frequency rate according to the TV signals, the apparatus digitizes an analog television signal to assemble an entire frame of digital video words in a video frame memory. Then, the apparatus transfers the digital video words from the video frame memory to a processing bus, and finally displays the TV program on the computer screen via a graphic card mounted in the computer system.

In the above-described computer-TV system, the conventional TV card presents in the form of extended computer card, and the related TV signals are outputted via the graphic card of the computer system. If a user wants to watch TV program through the TV card, the computer system needs to be switched on first, and subsequently a driving program therefore is used to activate the TV card. FIG. 1 shows the flow chart of the prior art.

To begin, the computer system is turned on (step S101), and performs the power-on-self-test (P.O.S.T.) process (step S103). After that, whether the computer system enters a standby mode is determined; namely, the computer system can resume the operating state from the standby mode at anytime (step S105). If the computer system is in the standby mode, the system resumes as a normal operating mode and restores the data saved in system memory (step S107). Next, the computer system enters the operating system such as Windows, Linux or Macintosh (step S109). Otherwise, if the computer system is not in the standby mode as when booting in the determining step (S105), the system launches the operating system directly (step S117), and enters the operating system (step S109). The computer system activates the peripheral devices first when entering the operating system (step S111); for example, the peripheral devices can be a TV card, video card, or converting card. After that, the multimedia software, such as DVD or VCD player, is used to display audio or video content (step S113), and the user views the content in final step S115.

U.S. Application Publication No. 2003/0076346 discloses a television card installed in a computer. FIG. 2 shows the television signals controlling steps of watching the TV program without booting the computer system.

A computer system 22 includes a remote signal processing part 221 receiving the signals from a PC remote controller 20, which includes a remote signal receiving part 223 and a micro-controller 225 both receiving the remote signals. The computer system 22 further includes a central processing unit (CPU) 227, a TV card 228 in charge of outputting the video signals, and a graphic card 229. The micro-controller 225 of the remote signal processing part 221 processes the signals transferred from the remote signal receiving part 223, and then a controlling signal is transmitted to the TV card 228 or the CPU 227 of the computer system 22 according to the remote signals thereof. The TV card 228 receives the TV signals received by an antenna 26. The TV signals are converted to TV video/audio signals, and TV program 241 herewith is displayed on a display apparatus 24, or the CPU 227 is used to transmit the computer system signals, and the content is displayed on the display apparatus 24 tlrough the graphic card 229.

The TV card 228 processing the TV signals is independent from the graphic card 229 in charge of processing the computer signals in the structure described in prior art. Since the TV system and the computer system are two stand-alone and power-independent systems, the TV card 228 is controlled by the remote controller without being processed by the CPU 227 of the computer system 22. That is, the user can watch the TV program without booting the computer system therein.

The information appliance (IA) used in the living room needs to overcome the redundant booting process used in computer system as the instant use of household appliance. Since the popular known operating systems, such as Windows, Linux and Macintosh, would not boot instantly as the mentioned appliance, the present invention discloses an instant switching method for a computer-television system. The computer-television system of the preferred embodiment of the present invention is separated into a computer operating module and a TV operating module, and not only introducing the independent TV and computer signals processing, also mentioning the computer system therein is disposed to the TV system.

### SUMMARY OF THE INVENTION

An instant switching method for a computer-television system is described. The computer-television system is provided, and comprises a computer system disposed in the TV system. A computer operating module and a TV operating module operate individually to achieve instant system switching. Under the television operation mode, if a specific function including computer, video or the like is demanded, the computer-television system can be switched to the computer mode instantly since the computer operating module is already in the process of booting beforehand.

In the preferred embodiment of the instant switching method of the present invention, the computer-television system is turned on, and then the television operating module and the computer operating module therein launch simultaneously. The television mode is entered in advance; the television operating module thereof controls an input/output system, and displays the audio/video content employing a video output device. Meanwhile, the television module checks whether the system is switched to the computer mode. If the computer mode is demanded, the computer mode is entered, and the computer operating module controls the input/output system and then perfonns the computer operation. Meanwhile, the computer operating module also checks whether the system is switched to the television mode.

The other preferred embodiment of the present invention includes launching simultaneously the television operating module and the computer operating module therein after the computer-television system starts. The television mode is entered first, and then the module thereof controls an input/output system of the system, and outputs the television program. In the meantime, the computer operating module performs a power-on-self-test (POST), and enters a standby status after finishing the booting procedure of the computer operating module. The television operating module determines whether the television mode is switched to the computer mode. If the computer mode is required, then the computer operating module controls the input/output system, such as video output and audio output, and performs the computer operation. Meanwhile, the computer operating module monitors the switching status.

### BRIEF DESCRIPTION OF DRAWINGS

The present invention will be readily understood by the following detailed description in conjunction with the accompanying drawings, in which:

FIG. 1 shows an operating flowchart of the computer-television system of the prior art;

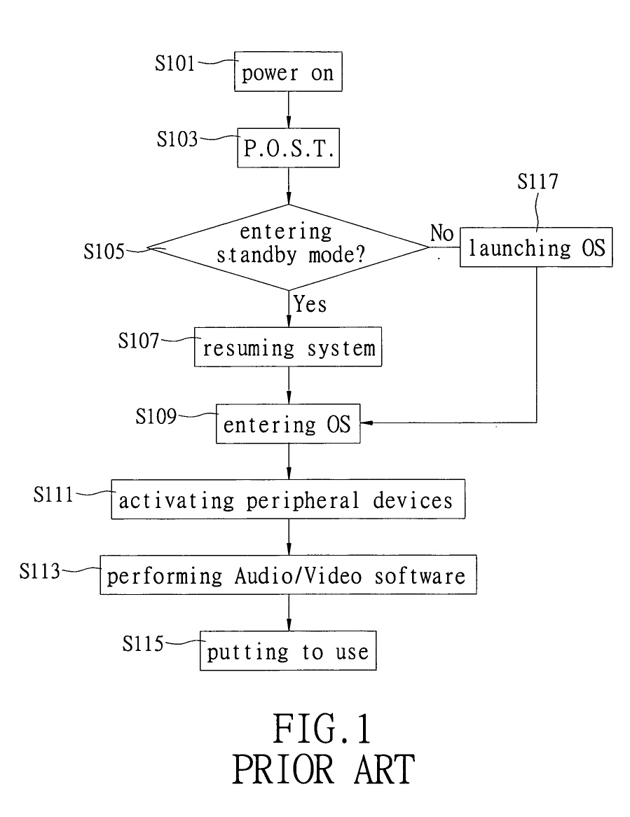

FIG. 2 is a block diagram of the TV card of the prior art;

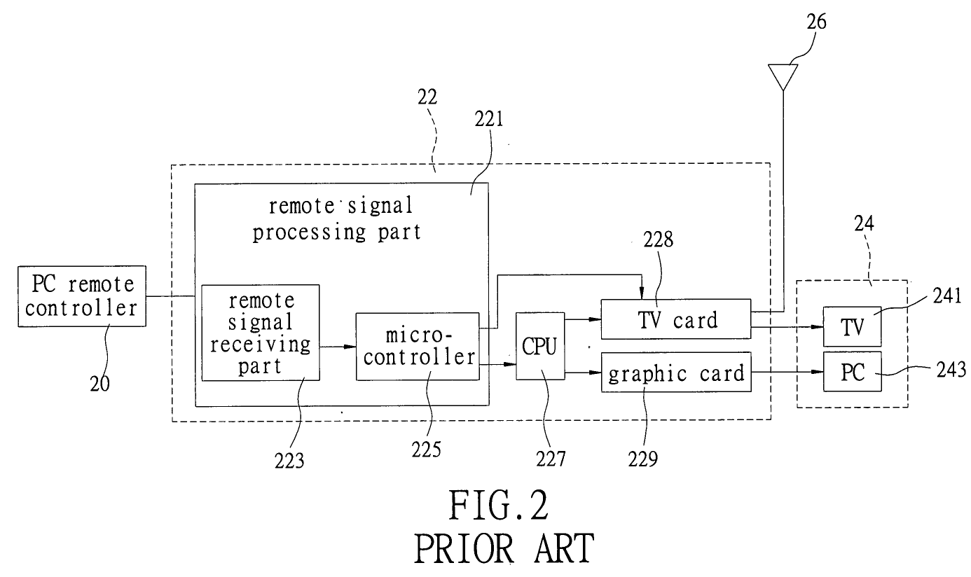

FIG. 3 is a schematic diagram of a computer-television system of the present invention;

FIG. 4 is a block diagram of the computer-television system of the present invention;

FIG. 5 shows a flowchart of the preferred embodiment of the present invention;

FIG. 6 shows a flowchart of the preferred embodiment of the present invention.

### DETAILED DESCRIPTION OF THE PREFERRED EMBODIMENTS

To allow the examiner to understand the technology, means and functions adopted in the present invention, further reference is made to the following detailed description and attached drawings. The examiner shall readily understand the invention deeply and concretely from the purpose, characteristics and specification of the present invention. Nevertheless, the present invention is not limited to the attached drawings and embodiments in following description.

An instant switching method for a computer-television system is described. The computer-television system is provided, comprising a computer system disposed in a TV system, and a computer operating module and a TV operating module therein that operate individually. The conventional computer system part is merely an input of the whole system, and the booting procedure of the system is like that of the conventional television system. The computer operating module and the television operating module operate separately to achieve the purpose of instantly switching the system of the present invention. If a function of the computer system including the recording capability is demanded, the computer-television system can be switched to the computer mode instantly since the computer operating module is already in the process of booting beforehand in the television operation mode.

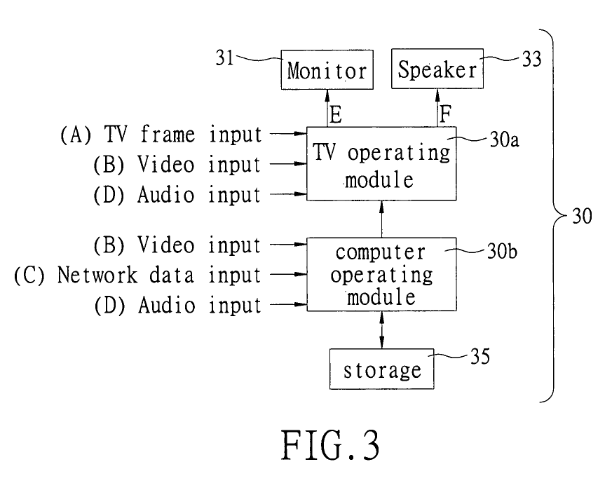

FIG. 3 shows a preferred embodiment of a computer-television system of the present invention. A computer-television system 30 is provided, and the system 30 is separated into a television operating module 30a and a computer operating module 30b. In particular, the computer operating module 30b is attached to the television operating module 30a, and the two modules 30a, 30b share an input/output system and interfaces thereon. When booting the system, the television operating module 30a launches first by turning on the regular television; in the meantime, the computer operating module 30b boots as well. If the computer-related function or the like is on demand, the computer-television system 30 can be switched to computer mode instantly if the selection key is used since the computer operating module 30b is on beforehand.

Reference is made to FIG. 3. A plurality of TV signals input (A) from the TV antenna or cable TV is received by a TV tuner within the television operating module 30a. Next, a video output signal E is outputted from a monitor 31, and an audio output signal F is outputted from a speaker 33, which is externally expanded or built in the computer. Otherwise, the computer-television system provides a plurality of input sources of the television operating module 30a, such as the video input (B) shown in diagram. The video input (B) can be DVD (Digital Versatile Disc), VCD (Video Compact Disc), or videotape. Alternatively, input can be audio input (D), like a CD (Compact Disc) player, an MP3 (MPEG level 3) player, a radio, or live singing.

The computer operating module 30b of the preferred embodiment can receive the video input (B), such as DVD or VCD, and even network data input (C) including the A/V content retrieved from a network. The audio input (D), such as the CD player and MP3 player, is also included through the input/output system (monitor 31 and speaker 32) of the computer-television system.

With the combination of the computer system and the television system, the storage 35 coupled with the computer operating module 30b can be used to make A/V content or any TV program, video or music.

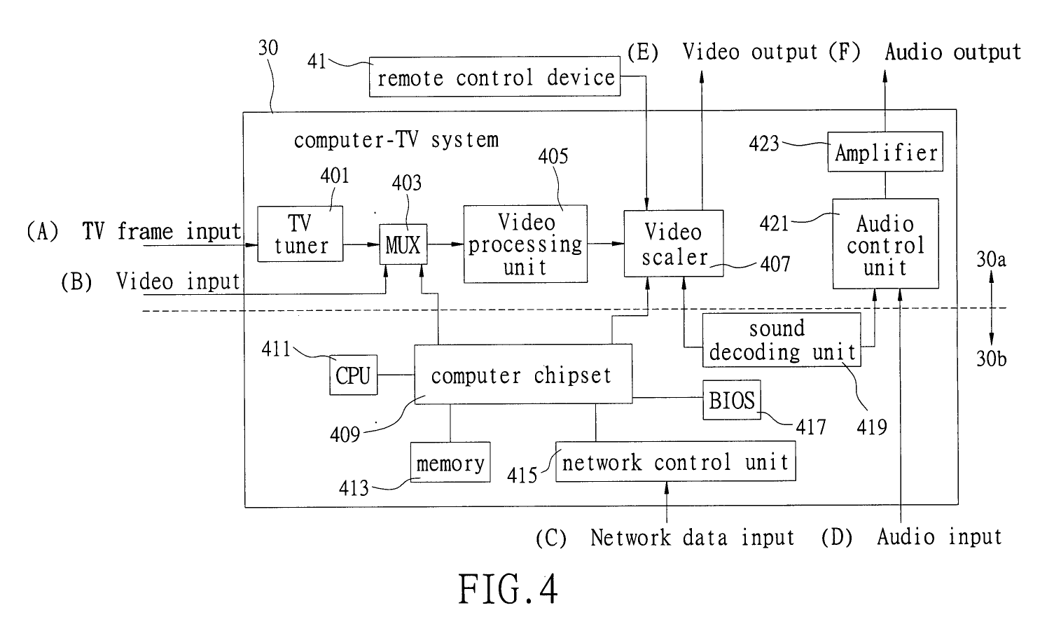

FIG. 4 shows the block diagram of preferred embodiment of the present invention. A computer system shown in the diagram is disposed in a television system so as to combine two modules including the television operating module 30a and the computer operating module 30b. A wired or wireless remote control device 41 of the computer-television system 30 controls the input/output signals switching; for example, the device 41 is used to select the video source is computer display, TV frames input (A), video inputs B, or network data input C. The audio source is the audio input (D) from the TV sound or other media input. Finally, the input/output signals are outputted using a TV monitor, the video output (E) and audio output (F).

The computer-television system 30 includes the television operating module 30a and computer operating module 30b, separately. The television operating module 30a operates as stand-alone module without activating the computer operating module 30b. When the regular audio/video player, the computer-television system, receives signals from the TV frame input (A), such as TV antenna or cable TV, from the regular video input (B), such as a DVD/VCD player or video tape, from the audio input (D), such as a CD player or MP3 player, the system also transmits the signals from the video output (E), like a TV monitor, or from the audio output (F), like a speaker. Furthermore, the computer-television system retrieves network A/V data like network streaming music, audio/video or movies.

The aforementioned TV operating module 30a of the computer-TV system 30 includes a TV tuner 401 for receiving the TV signals. The TV tuner 401 couples to the TV operating module 30a and receives video signals transmitted from the external video input (B) or the computer chipset 409. The received TV signals, afterwards, are converted into digital signals by a video processing unit 405. Then the digital signals are transmitted to a video scaler 407 and later being outputted. The video scaler 407 further receives the various video signals transmitted from the chipset 409 of the computer operating module 30b.

The TV operating module 30a of the computer-television system 30 can operate as a stand-alone device without turning on the computer operating module 30b therein. The TV frame input (A) is transmitted to the video processing unit 405 through the TV tuner 401 and multiplexer 403, and is outputted as the video output (E) shown in diagram via the video scaler 407. Otherwise, other video input (B) is also transmitted to the video processing unit 405 through the multiplexer 403, and output as the video output (E) via the video scaler 407. Moreover, the audio input (D) is processed by an audio control unit 421, and output as the audio output (F) via an amplifier 423.

Since both the TV operating module 30a and the computer operating module 30b launch simultaneously, and the TV operating module 30a is first entered, so as the computer-television system is switched to the computer operating module 30b, the system can instantly enter a regular computer operating system (OS), such as Windows, Linux or Macintosh. In particular, the TV monitor is also the output display of the computer operating system. The network data input (C) is received by a network control unit 415 connecting to a local area network (LAN) or Internet, and processed through the computer chipset 409. Further, a BIOS 417 coupled with the chipset 409 is used as the I/O controlling of the data transmission by the peripheral devices thereof. Those input signals, including the TV frame input (A), video input (B), network data input (C) and the audio input (D), will be processed by a central processing unit (CPU) 411, and stored by a memory 413. An exemplary embodiment describes the audio input data thereof is decoded by a sound decoding unit 419, transmitted by the audio control unit 421, and output as the audio output (F) through the amplifier 423.

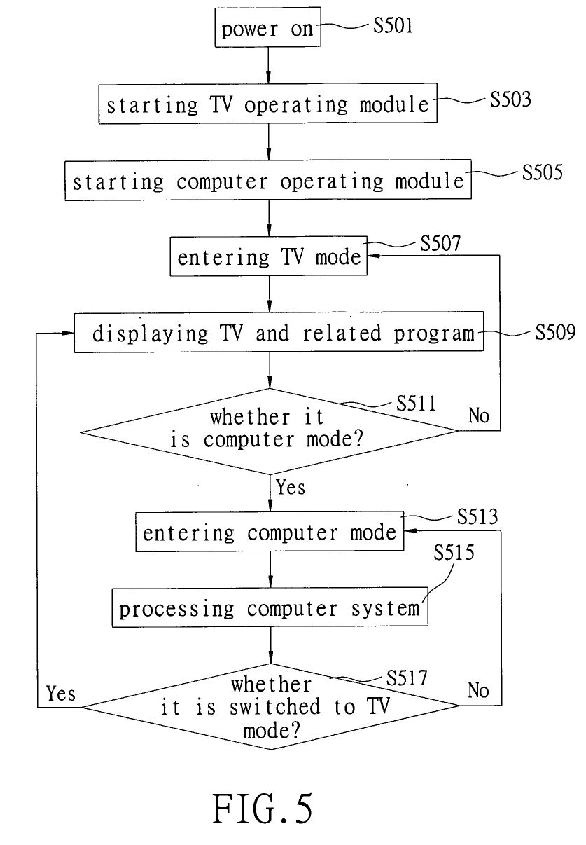

FIG. 5 shows a flowchart of the instant switching method for the computer-TV system of the preferred embodiment. If the computer mode within the system of the present invention is requested, for example, the selection key is used to switch the system to the computer mode, the system can be instantly switched since the computer operating module finishes the booting process beforehand. The method includes the following steps.

After the computer-television system is turned on in the beginning (step S501), the TV operating module starts (step S503); meanwhile, the computer operating module starts (step S505). The TV mode is first entered in the preferred embodiment; namely, the TV operating module thereof controls the input/output system in advance, and the input/output system is used by both the TV operating module and the computer operating module. The video output device is like the TV monitor, the audio output device is like the speaker, and the input device is like the keyboard or the remote control device (step S507). After that, the video monitor displays the TV and related program received via the TV antenna or cable, or the A/V content such as DVD/VCD/CD/MP3 (step S509).

Under the process of the TV mode, a program therein determines whether the system is switched to the computer mode (step S511). Step S507 and step S509 under the TV mode proceed if there is no switching instruction. However, if the selection key is used to switch to the computer mode, namely, the computer operating module takes over the input/output system, the computer mode is entered (step S513). In the meantime, the peripheral devices, such as the monitor and the speaker, of the computer-TV system are used for the computer system, which processes the A/V content output from Internet or a DVD/VCD/CD/MP3 player, or sound effects stored in the computer (step S515). In the computer mode, the program therein determines whether the system is switched to the TV mode (step S517). Step S513 and step S515 under the computer mode proceed if there is no switching instruction. However, if the TV mode is requested, namely, the TV operating module takes over the input/output system, the TV mode is entered.

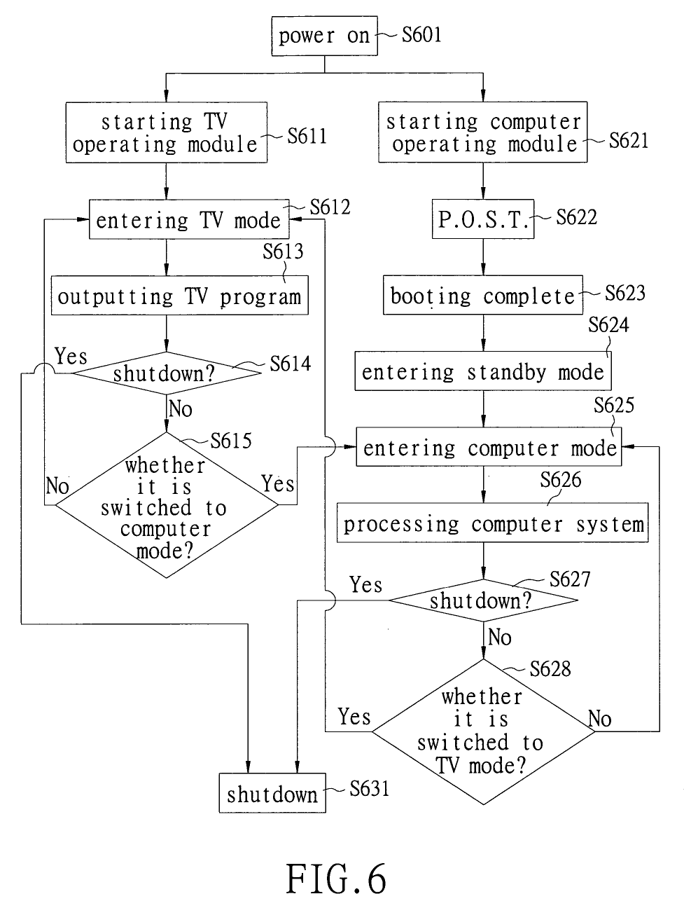

Reference is made to FIG. 6, which is the flowchart of the preferred embodiment of the present invention. To begin, the computer-TV system is turned on (step S601). In the meantime, the TV operating module starts (step S611), and the computer operating module starts as well (step S621). Next, the system enters the TV mode first. Without spending extra booting hours, the TV operating module has priority to control the input/output devices, such as monitor, speaker, keyboard, controller for the same, or the like (step S612). Then the TV program is outputted via the various I/O devices of the system mentioned above (step S613). On this moment, the computer operating module performs the power-on-self-test (POST) of the computer system (step S622), then completes the booting steps (step S623) and enters a standby status waiting for the switching instruction from the TV mode to the computer mode (step S624).

When the TV mode is in process, a routine program is used to detect the instruction to shut down the system (step 614). If the system receives the shutdown instruction or automatically turns off the power of the system under a particular condition, the system performs the shutdown procedure (step S631). If the system doesn't receive the shutdown instruction, the system proceeds to wait for the switching instruction from TV mode to the computer mode (step S615). If the system receives no switching instruction, the television mode is in process (step S612); if the system receives the switching instruction, the computer mode is entered since the computer operating module takes over the input/output system (step S625). Then the computer system is in process, and the A/V content therein can be used (step S626).

When the computer operating module takes over the input/output system, the computer operating system processes and detects the system shutdown instruction (step S627), and the switching instruction from the computer mode to the TV mode (step S628). The shutdown procedure in step S631 is processed if the system receives the shutdown instruction, the TV mode in step S612 is entered if the system receives the switching instruction from the computer mode.

To conclude, an instant switching method for a computer-television system is disclosed. A TV operating module and a computer operating module are two parts of the computer-TV system. When the system launches, these two parts operate individually. First, the TV mode therein is entered, then the system can be switched instantly to the computer mode since the computer operating module completes the booting procedure in the meantime.

The invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A computer-television system, comprising:
a TV operating module installed in the computer-television system;
a computer operating module and the TV operating module from the computer-television system;
a plurality of video and audio input devices coupled with the computer-television system;
an audio output device coupled with the computer-television system;
a video output device coupled with the computer-television system;
and
a TV tuner coupled to the TV operating module, and used to receive the TV signals.

2. The computer-television system as recited in claim 1, wherein the TV operating module of the system comprises:
a storage coupled with the computer operating module;
a video processing unit coupled with the computer-television operating module, wherein the video processing unit is used to receive video signals of a multiplexer and then transform the video signals into digital signals; and
a video transforming unit, wherein video transforming unit receives the video signals transmitted through a plurality of transmitting interfaces, and is adopted by a chipset of the computer operating module.

3. The computer-television system as recited in claim 1, wherein a remote control device is used to switch the television operating module and the computer operating module.

4. The computer-television system as recited in claim 1, wherein the computer operating module further includes a network control unit connecting to a local area network or Internet.

5. The computer-television system as recited in claim 1, wherein the chipset of the computer operating module couples with a basic input/output system (BIOS), a central processing unit (CPU), a memory and a sound decoding unit.

6. An instant switching method for a computer-television system, wherein the computer-television system includes a television operating module and a computer operating module, the method comprises comprising:
switching the computer-television system on;
starting the television operating module;
starting the computer operating module;
entering a television mode, wherein an input/output system is controlled by the television module;
displaying a television program by employing a video output device and an audio output device;
determining whether the computer-television system is switched to a computer mode;
entering the computer mode, wherein the input/output system is controlled by the computer operating module;
processing the computer system; and
determining whether the computer-television system is switched to the television mode.

7. The instant switching method as claim 6, wherein the television operating module and the computer operating module start simultaneously.

8. The instant switching method as claim 6, wherein the computer system enters a standby mode after performing a power-on-self-test (P.O.S.T.) process when the computer operating module starts.

9. The instant switching method as claim 6, wherein in the step of determining whether the computer-television system is switched to the television mode, if there is no switching instruction, the computer mode is in process, and if the computer-television system is instructed to switch to the television mode, the television operating module within controls the input/output system.

10. The instant switching method as claim 6, wherein in the step of determining whether the computer-television system is switched to the computer mode, if there is no switching instruction, the television mode is in process, and if the computer-television system is instructed to switch to the computer mode, the computer operating module within controls the input/output system.

11. The instant switching method as claim 6, wherein the video output device is a television monitor.

12. The instant switching method as claim 6, wherein the audio output device is a speaker.

13. The instant switching method as claim 6, wherein the input/output system further includes a plurality of video input devices and audio input devices.

14. An instant switching method for a computer-television system, comprising:
switching the computer-television system on;
starting a television operating module and a computer operating module, simultaneously;
entering a television mode, wherein an input/output system is controlled by the television module;
outputting a television program;
performing a power-on-self-test process of the computer operating module;
entering a standby mode after accomplishing a booting process of the computer operating module;
determining whether the computer-television system is switched to a computer mode;
entering the computer mode, wherein the computer operating module controls the input/output system having a video output and an audio output;
processing the computer system, and
determining whether the computer-television system is switched to the television mode.

15. The instant switching method as claim 14, wherein in the television mode or the computer process, a detecting process constantly operates to determine whether the computer-television system is turned off.

16. The instant switching method as claim 14, wherein in the step of determining whether the computer-television system is switched to the computer mode, if there is no switching instruction, the television mode is in process.

17. The instant switching method as claim 14, wherein in the step of determining whether the computer-television system is switched to the computer mode, if the computer-television system is instructed to switch to the computer mode, the computer operating module within controls the input/output system and enters the computer mode.

18. The instant switching method as claim 14, wherein in the step of determining whether the computer-television system is switched to the television mode, if there is no switching instruction, the computer mode is in process.

19. The instant switching method as claim 14, wherein in the step of determining whether the computer-television system is switched to the television mode, if the computer-television system is instructed to switch to the television mode, the television operating module within controls the input/output system and enters the television mode.

20. The instant switching method as claim 14, wherein the input/output system includes an audio output device, a video output device, and a plurality of video and audio input devices.
